(19) United States
(12) Patent Application Publication
(10) Pub. No.: US 2012/0188956 A1
(43) Pub. Date: Jul. 26, 2012

(54) METHOD, DEVICE, AND SYSTEM FOR ALLOCATING AIR INTERFACE RESOURCE

(75) Inventor: Ning Dong, Beijing (CN)

(73) Assignee: HUAWEI TECHNOLOGIES CO., LTD., Shenzhen (CN)

(21) Appl. No.: 13/356,375

(22) Filed: Jan. 23, 2012

(30) Foreign Application Priority Data
Jan. 24, 2011 (CN) 201110024853.5

(51) Int. Cl. H04W 72/04

(52) U.S. Cl. 370/329

(57) ABSTRACT

In the field of communications, a method, a device, and a system for allocating an air interface resource are provided. The method includes: acquiring, according to the amount of data buffered in a buffer corresponding to the channel group, a first level and a second level that are corresponding to the channel group, where the first level is used to indicate a numerical value range, and the second level is used to further indicate a numerical value range of the amount of the data in the numerical value range; filling a Buffer Status Report (BSR) control element of a BSR message with the first level, and filling a BSR sub-header of the BSR message with the second level; and sending the BSR message to a base station, and requesting the base station to allocate the air interface resource.

### CROSS-REFERENCE TO RELATED APPLICATION

This application claims priority to Chinese Patent Application No. 201110024853.5, filed on Jan. 24, 2011, which is hereby incorporated by reference in its entirety.

### FIELD OF THE INVENTION

The present invention relates to the field of communications, and in particular, to a method, a device, and a system for allocating an air interface resource.

### BACKGROUND OF THE INVENTION

In a wireless communication system, before a terminal sends data to a base station through a channel group, the base station needs to firstly determine a size of an air interface resource allocated to the channel group, and then allocates the air interface resource of the determined size. Next, the terminal sends the data to the base station through the channel group and by utilizing the allocated air interface resource.

In the prior art, a method for allocating an air interface resource is provided. Specifically, a terminal and a base station store a same table of a mapping relationship between numerical value ranges and BSR (Buffer Status Report, buffer status report) levels in advance. When the terminal needs to transmit data through a channel group, the terminal counts the amount of data buffered in a buffer corresponding to the channel group, determines a numerical value range of the counted amount of the data, acquires a corresponding BSR level from the table of the mapping relationship between the numerical value ranges and the BSR levels according to the determined numerical value range, fills the BSR message with the acquired BSR level, and sends the BSR message to the base station. The base station receives the BSR message, extracts the BSR level from the BSR message, acquires, according to the extracted BSR level, a corresponding numerical value range from the table of the mapping relationship between the numerical value ranges and the BSR levels, determines a maximum of the acquired numerical value range as a size of the air interface resource allocated to the channel group, and then allocates the air interface resource of the determined size.

The BSR message includes a BSR sub-header and a BSR control element. The BSR control element includes a buffer size field, where the buffer size field occupies 6 bits and is filled with the BSR level. Therefore, 64 BSR levels exist, that is, a 0^{th} level to a 63^{th} level, and each BSR level corresponds to a numerical value range, so that the table of the mapping relationship between the numerical value ranges and the BSR levels stored in the terminal and the base station only has 64 BSR levels and 64 numerical value ranges.

During the implementation of the present invention, the inventor finds that the prior art at least has the following problems.

The BSR message may only be filled with 64 BSR levels, each BSR level corresponds to one numerical value range, and division of the numerical value range is not refined enough, so that a difference value between the size of the air interface resource determined by the base station and the amount of data buffered in the buffer of the terminal is great, so a great amount of air interface resources are not fully utilized. However, in the wireless communication field, the air interface resource is quite precious, and the unnecessary waste of the air interface resource in the prior art lowers a utilization ratio of communication resources.

### SUMMARY OF THE INVENTION

In order to improve a utilization ration of an air interface resource, embodiments of the present invention provide a method, a device, and a system for allocating an air interface resource. Technical solutions are described in the following.

A method for allocating an air interface resource includes:

acquiring, according to the amount of data buffered in a buffer corresponding to the channel group, a first level and a second level that are corresponding to a channel group, where the first level is used to indicate a numerical value range, and the second level is used to further indicate, in the numerical value range, a numerical value range of the amount of the data;

filling a BSR control element of a BSR message with the first level, and filling a BSR sub-header of the BSR message with the second level; and

sending the BSR message to a base station, and requesting the base station to allocate the air interface resource.

A method for allocating an air interface resource includes:

receiving a BSR message, and respectively extracting a first level and a second level that are corresponding to a channel group from a BSR control element and a BSR sub-header of the BSR message, where the first level is used to indicate a numerical value range, and the second level is used to further indicate, in the numerical value range, a more specific numerical value range;

acquiring a size of the air interface resource allocated to the channel group according to the first level and the second level; and

allocating the air interface resource of the size to the channel group.

A terminal includes:

a first acquiring module, configured to acquire a first level and a second level corresponding to a channel group according to the amount of data buffered in a buffer corresponding to the channel group, where the first level is used to indicate a numerical value range, and the second level is used to further indicate, in the numerical value range, a numerical value range of the amount of the data;

a first filling module, configured to fill a BSR control element of a BSR message with the first level, and fill a BSR sub-header of the BSR message with the second level; and

a sending module, configured to send the BSR message to a base station, and request the base station to allocate the air interface resource.

A base station includes:

a first extracting module, configured to receive a BSR message, and respectively extract a first level and a second level that are corresponding to a channel group from a BSR control element and a BSR sub-header of the BSR message, where the first level is used to indicate a numerical value range, and the second level is used to further indicate, in the numerical value range, a more specific numerical value range;

a second acquiring module, configured to acquire a size of the air interface resource allocated to the channel group according to the first level and the second level; and

an allocating module, configured to allocate the air interface resource of the size to the channel group.

In the embodiments of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of data buffered in a terminal, and thereby a utilization ratio of the air interface resource is improved, and the air interface resource is saved.

### BRIEF DESCRIPTION OF THE DRAWINGS

FIG. 1 is a flow chart of a method for allocating an air interface resource according to Embodiment 1 of the present invention;

FIG. 2 is a flow chart of a method for allocating an air interface resource according to Embodiment 2 of the present invention;

FIG. 3 is a flow chart of a method for allocating an air interface resource according to Embodiment 3 of the present invention;

FIG. 4 is a flow chart of a method for allocating an air interface resource according to Embodiment 4 of the present invention;

FIG. 5 is a schematic diagram of a terminal according to Embodiment 5 of the present invention;

FIG. 6 is a schematic diagram of a base station according to Embodiment 6 of the present invention; and

FIG. 7 is a schematic diagram of a system for allocating an air interface resource according to Embodiment 7 of the present invention.

### DETAILED DESCRIPTION OF THE EMBODIMENTS

In order to make objectives, technical solutions, and advantages of the present invention more comprehensible, a detailed description of the present invention is given below with reference to accompanying drawings.

If a buffer corresponding to a channel group of a terminal buffers data required to be transmitted to a base station, the terminal sends a BSR message to the base station, so as to request the base station to allocate an air interface resource that is used to transmit the data. The BSR message includes a BSR sub-header and a BSR control element, and the BSR message may also be classified into a short BSR message and a long BSR message. If the buffer of only one channel group for the terminal buffers the data required to be transmitted, the BSR message sent by the terminal is the short BSR message; if the buffers of multiple channel groups for the terminal buffer the data required to be transmitted, the BSR message sent by the terminal is the long BSR message.

The short BSR message includes a BSR sub-header and a BSR control element, as shown in Table 1, the BSR sub-header of the short BSR message includes a BSR identifying field LC ID, an extending domain identifying field E, and a reserved field RR, where the identifying field LC ID occupies 5 bits, has a value of 11101, and is configured to identify the short BSR message, the extending domain identifying field E occupies 1 bit, and the reserved field RR occupies 2 bits and has a value of null.

TABLE 1

| R R | | E | LC ID | | | | |
|---|---|---|---|---|---|---|---|
| 0 | 0 | 0 | 1 | 1 | 1 | 0 | 1 |

As shown in Table 2, the BSR control element of the short BSR message includes a channel group identifier LCG ID and a buffer size field Buffer Size, where the buffer size field Buffer Size occupies 6 bits, and the channel group identifier LCG ID occupies 2 bits, so that at most 4 channel groups exist between the terminal and the base station.

TABLE 2

| LCG ID | | Buffer Size | | | | | |
|---|---|---|---|---|---|---|---|
| 0 | 1 | 1 | 1 | 1 | 1 | 1 | 0 |

If the buffers of multiple channel groups for the terminal buffer the data required to be transmitted, the terminal sends the long BSR message to the base station. The long BSR message includes a BSR sub-header and a BSR control element, as shown in Table 3, the BSR sub-header of the long BSR message includes a BSR identifying field LC ID, an extending domain identifying field E, and a reserved field RR; the identifying field LC ID occupies 5 bits, has a value of 11110, and is configured to identify the long BSR message, the extending domain identifying field E occupies 1 bit, and the reserved field RR occupies two bits and has a value of null.

TABLE 3

| R R | | E | LC ID | | | | |
|---|---|---|---|---|---|---|---|
| 0 | 0 | 0 | 1 | 1 | 1 | 1 | 0 |

The BSR control element of the long BSR message includes multiple buffer size fields Buffer Size, as shown in Table 4, the BSR control element of the long BSR message includes 4 buffer size fields Buffer Size, and each buffer size field Buffer Size occupies 6 bits.

TABLE 4

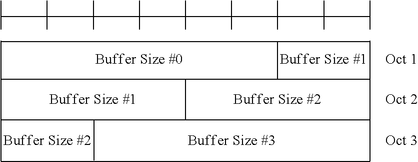

### Embodiment 1

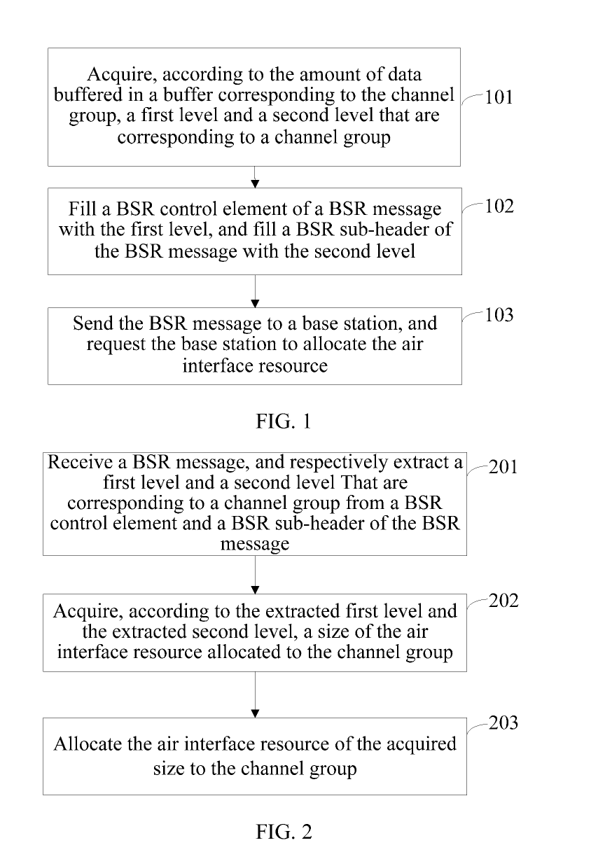

As shown in FIG. 1, an embodiment of the present invention provides a method for allocating an air interface resource, which includes the following steps:

Step 101: Acquire, according to the amount of data buffered in a buffer corresponding to the channel group, a first level and a second level that are corresponding to a channel group.

The first level is used to indicate a numerical value range, and the second level is used to further indicate, in the numerical value range indicated by the first level, a numerical value range of the amount of data buffered in the buffer.

Step 102: Fill a BSR control element of a BSR message with the first level, and fill a BSR sub-header of the BSR message with the second level.

Step 103: Send the BSR message to a base station, and request the base station to allocate the air interface resource.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of data buffered in a terminal, and thereby a utilization ratio of the air interface resource is improved, and the air interface resource is saved.

### Embodiment 2

As shown in FIG. 2, an embodiment of the present invention provides a method for allocating an air interface resource, which includes the following steps:

Step 201: Receive a BSR message, and respectively extract a first level and a second level that are corresponding to a channel group from a BSR control element and a BSR sub-header of the BSR message.

The first level is used to indicate a numerical value range, and the second level is used to further indicate, in the numerical value range indicated by the first level, a more specific numerical value range.

Step 202: Acquire, according to the extracted first level and the extracted second level, a size of the air interface resource allocated to the channel group.

Step 203: Allocate the air interface resource of the acquired size to the channel group.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of data buffered in a terminal, and thereby a utilization ratio of the air interface resource is improved, and the air interface resource is saved.

### Embodiment 3

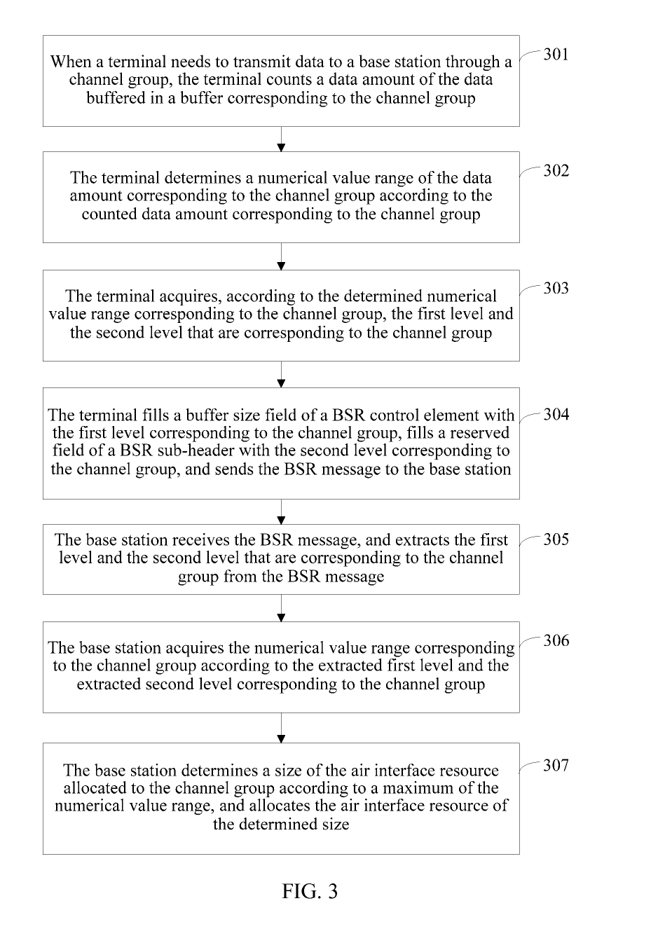

An embodiment of the present invention provides a method for allocating an air interface resource. When a terminal needs to send data to a base station through a channel group, the terminal sends a short BSR message to the base station, so as to request the base station to determine a size of the air interface resource and allocate the air interface resource of the determined size. Referring to FIG. 3, the method includes the following steps:

Step 301: When a terminal needs to transmit data to a base station through a channel group, the terminal counts a data amount of the data buffered in a buffer corresponding to the channel group.

Each channel group between the terminal and the base station has a corresponding buffer, and before the terminal sends the data to the base station through a certain channel group, the data required to be sent is buffered in the buffer corresponding to the channel group. After the data required to be sent is buffered in the buffer corresponding to the channel group, the terminal needs to request the base station to allocate the air interface resource that is used to transmit the data.

For example, the terminal needs to transmit the data to the base station through a channel group corresponding to a channel group identifier 2 and enables the data required to be transmitted to be buffered in the buffer corresponding to the channel group, and then the terminal counts the data amount in the buffer corresponding to the channel group, where a binary code of the channel group identify 2 is 10, and the data amount counted by the terminal count is 100 bytes.

Step 302: The terminal determines a numerical value range of the data amount corresponding to the channel group according to the counted data amount corresponding to the channel group.

In this embodiment, 64 numerical value ranges in an existing table of the mapping relationship between the numerical value ranges and the BSR levels are further divided. Specifically, for any record in the existing table of the mapping relationship between the numerical value ranges and the BSR levels, a BSR level in the record is used as the first level, a numerical value range in the record is further divided to acquire multiple numerical value ranges, and each divided numerical value range is set to correspond to one second level, so that each divided data value range corresponds to a level combined by the first level and the second level. Then, each divided numerical value range, and the level combined by the first level and the second level corresponding to each numerical value range are stored in the table of the mapping relationship between the numerical value ranges and the levels. According to the method, the numerical value range of each other record in the existing table of the mapping relationship between the numerical value ranges and the BSR levels is divided. Therefore, a finally acquired table of the mapping relationship between the numerical value ranges and the levels includes 64 first levels, and each first level corresponds to multiple numerical value ranges, and each first level corresponds to multiple second levels.

For example, it is assumed that in the numerical value ranges and the BSR levels, there is a record that the numerical value range is 90 to 106 bytes and the BSR level is 5, the BSR level 5 in the record is used as the first level, and the numerical value range being 90 to 105 bytes in the record is divided into 4 numerical value ranges, being respectively 90 to 93 bytes, 94 to 97 bytes, 98 to 101 bytes, and 102 to 105 bytes; and each divided numerical value range is set with the second level, being respectively 0, 1, 2, and 3, so that the divided numerical value range being 90 to 93 bytes corresponds to a level combined by the first level 5 and the second level 0, the divided numerical value range being 94 to 97 bytes corresponds to a level combined by the first level 5 and the second level 1, the divided numerical value range being 98 to 101 bytes corresponds to a level combined by the first level 5 and the second level 2, and the divided numerical value range being 102 to 105 bytes corresponds to a level combined by the first level 5 and the second level 3. Then, the divided numerical value ranges and the levels combined by the first level and the second level are stored in the table of the mapping relationship between the numerical value ranges and the levels as shown in Table 5.

TABLE 5

| | |
|---|---|
| Numerical Value | Level |

| Range | First level | Second level |
|---|---|---|
| . . . | . . . | . . . |
| 90 to 93 bytes | 5 | 0 |
| 94 to 97 bytes | 5 | 1 |
| 98 to 101 bytes | 5 | 2 |
| 102 to 105 bytes | 5 | 3 |
| . . . | . . . | . . . |

According to the counted data amount being 100 bytes corresponding to the channel group, it is determined that the numerical value range of the data amount corresponding to the channel group is within 98 to 101 bytes.

In this embodiment, the terminal and the base station store the same table of the mapping relationship between the numerical value ranges and the levels, that is, the terminal and the base station store the table of the mapping relationship between the numerical value ranges and the levels as shown in Table 5.

In the embodiment of the present invention, the table of the mapping relationship between the numerical value ranges and the levels includes 64 first levels, where each first level corresponds to multiple numerical value ranges, so that the numerical value ranges in the table of the mapping relationship between the numerical value ranges and the levels in the terminal and the base station are more refined than the numerical value ranges in the existing table of the mapping relationship between the numerical value ranges and the BSR levels.

Step 303: The terminal acquires, according to the determined numerical value range corresponding to the channel group, the first level and the second level corresponding to the channel group.

Specifically, the terminal acquires the first level and the second level that are corresponding to the channel group from a stored table of the mapping relationship between the numerical value ranges and the levels according to the determined numerical value range corresponding to the channel group.

For example, according to the determined numerical value range being 98 to 101 bytes corresponding to the channel group, the first level 5 and the second level 2 corresponding to the channel group are acquired from the table of the mapping relationship between the numerical value ranges and the levels as shown in Table 5.

Step 304: The terminal fills a buffer size field of a BSR control element with the first level corresponding to the channel group, fills a reserved field of a BSR sub-header with the second level corresponding to the channel group, and sends the BSR message to the base station.

Further, the terminal may fill a channel group identifying field of the BSR control element with a channel group identifier.

For example, binary of the first level 5 is 000101, the terminal fills the buffer size field of the BSR control element with the first level 000101 corresponding to the channel group, and fills the channel group identifying field of the BSR control element with the channel group identifier 10, where an acquired BSR control element is as shown in Table 6.

| LCG ID | | Buffer Size | | | | | |
|---|---|---|---|---|---|---|---|
| 1 | 0 | 0 | 0 | 0 | 1 | 0 | 1 |

Binary of the second level 2 is 10, and the terminal fills the reserved field of the BSR sub-header with the second level 10 corresponding to the channel group, where an acquired BSR sub-header is as shown in Table 7.

TABLE 7

| R R | | E | LC ID | | | | |
|---|---|---|---|---|---|---|---|
| 1 | 0 | 0 | 1 | 1 | 1 | 0 | 1 |

The BSR message is formed by the BSR sub-header as shown in Table 7 and the BSR control element as shown in Table 6, and then the terminal sends the BSR message with the formation as shown in Table 7 and Table 6 to the base station.

In this embodiment, the reserved field of the BSR sub-header is filled with the second level, where the reserved field occupies 2 bits, so that each first level may correspond to 4 second levels at most, so each first level may correspond to 4 numerical value ranges at most.

Step 305: The base station receives the BSR message, and extracts the first level and the second level that are corresponding to the channel group from the BSR message.

Specifically, the base station receives the BSR message, extracts the first level from the BSR control element of the BSR message, and extracts the second level from the reserved field of the BSR sub-header of the BSR message.

Further, the base station may extract the channel group identifier from the BSR control element of the BSR message.

For example, the base station extracts the first level 5 and the channel group identifier 2 from the BSR control element of the BSR message, and extracts the second level 2 from the BSR sub-header of the BSR message.

Step 306: The base station acquires the numerical value range corresponding to the channel group according to the extracted first level and the extracted second level that are corresponding to the channel group.

Specifically, the base station acquires the numerical value range corresponding to the channel group from the stored table of the mapping relationship between the numerical value ranges and the levels according to the extracted first level and the extracted second level that are corresponding to the channel group.

Step 307: The base station determines a size of the air interface resource allocated to the channel group according to a maximum of the numerical value range, and allocates the air interface resource of the determined size.

After allocating the air interface resource with the determined size, the base station returns a response message to the terminal. Then, the terminal transmits the data buffered in the buffer corresponding to the channel group to the base station through the channel and by utilizing the allocated air interface resource. Definitely, during practical application, the size of the allocated air interface resource may be flexibly adjusted, that is, a value of a resource amount being slightly smaller than or greater than the maximum is used as the size of the allocated air interface resource, which is not limited in this embodiment.

For example, according to the first level 5 and the second level 2 that are corresponding to the channel group, the base station acquires the corresponding numerical value range being 98 to 101 bytes from the base's table of the mapping relationship between the numerical value ranges and the levels as shown in Table 5, and uses a maximum 101 of the acquired numerical value range as the size of the air interface resource allocated to a channel group, that is, the channel group corresponding to the channel group identifier 2.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of data buffered in a terminal, and thereby a utilization ratio of the air interface resource is improved, and the air interface resource is saved.

### Embodiment 4

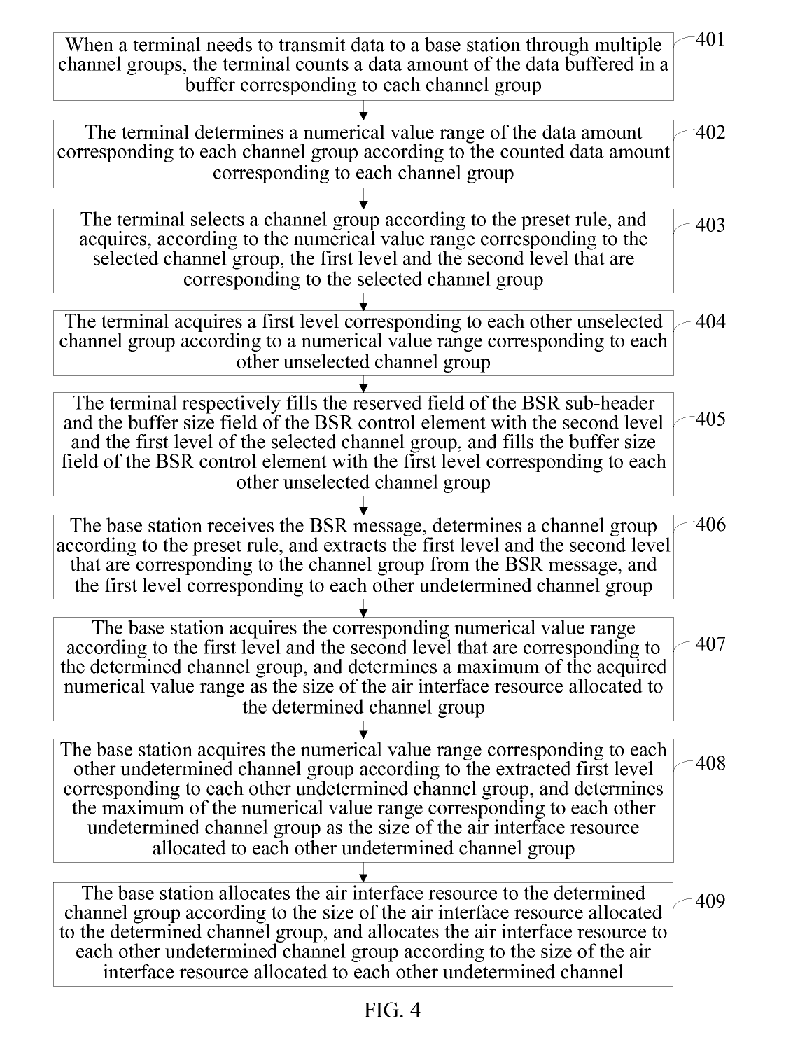

An embodiment of the present invention provides a method for allocating an air interface resource. When a terminal needs to send data to a base station through multiple channel groups, the terminal sends a long BSR message to the base station, so as to request the base station to determine a size of the air interface resource of each channel group and allocate the air interface resource to each channel group. Referring to FIG. 4, the method includes the following steps:

Step 401: When a terminal needs to transmit data to a base station through multiple channel groups, the terminal counts a data amount of the data buffered in a buffer corresponding to each channel group.

For example, the terminal includes four channel groups, being respectively a first channel group, a second channel group, a third channel group, and a fourth channel. The terminal needs to transmit the data by utilizing four channel groups, and count the amount of the data buffered in the buffer corresponding to each channel group. It is assumed that the amount of the data buffered in the buffer corresponding to the first channel group is 100 bytes, the amount of the data buffered in the buffer corresponding to the second channel group is 93 bytes, the amount of the data buffered in the buffer corresponding to the third channel group is 95 bytes, and the amount of the data buffered in the buffer corresponding to the fourth channel group is 96 bytes.

Step 402: The terminal determines a numerical value range of the data amount corresponding to each channel group according to the counted data amount corresponding to each channel group.

For example, the determined numerical value range of the data amount being 100 bytes corresponding to the first channel group is 98 to 101 bytes, the determined numerical value range of the data amount being 93 bytes corresponding to the second channel group is 90 to 93 bytes, the determined numerical value range of the data amount being 95 bytes corresponding to the third channel group is 94 to 97 bytes, and the determined numerical value range of the data amount being 96 bytes corresponding to the fourth channel group is 94 to 97 bytes.

In this embodiment, the terminal and the base station store a table of the mapping relationship between the numerical value ranges and the levels as shown in Table 5. In addition, the terminal further sends the long BSR message to the base station, and the long BSR message includes a BSR sub-header, but the BSR control element includes multiple buffer size fields, so that the BSR sub-header of the long BSR message is only filled with the second level of one channel. In this embodiment, a channel group may be selected according to a preset rule, the BSR sub-header and the BSR control element are filled with the second level and the first level of the selected channel group respectively, and the BSR control element is filled with the first levels corresponding to other unselected channel groups. The preset rule may be that a channel group with the maximum priority is selected.

In the embodiment of the present invention, the table of the mapping relationship between the numerical value ranges and the levels includes 64 first levels, where each first level corresponds to multiple numerical value ranges, so that the numerical value ranges in the table of the mapping relationship between the numerical value ranges and the levels in the terminal and the base station are more refined than the numerical value ranges in the existing table of the mapping relationship between the numerical value ranges and the BSR levels.

Step 403: The terminal selects a channel group according to the preset rule, and acquires, according to the numerical value range corresponding to the selected channel group, the first level and the second level that are corresponding to the selected channel group.

Specifically, a channel group is selected according to the preset rule, and the first level and the second level that are corresponding to the selected channel group are acquired from the stored table of the mapping relationship between the numerical value ranges and the levels according to the numerical value range corresponding to the selected channel group.

For example, it is assumed that the priority of the first channel group is the maximum, the first channel group is selected according to the preset rule, and the first level 5 and the second level 2 that are corresponding to the first channel group are acquired from the table of the mapping relationship between the numerical value ranges and the levels as shown in Table 5 according to the numerical value range being 98 to 101 bytes corresponding to the first channel group.

Step 404: The terminal acquires a first level corresponding to each other unselected channel group according to a numerical value range corresponding to each other unselected channel group.

Specifically, the terminal acquires the first level corresponding to each other unselected channel group from the stored table of the mapping relationship between the numerical value ranges and the levels according to the numerical value range corresponding to each other unselected channel group.

For example, other unselected channel groups are respectively the second channel group, the third channel group, and the fourth channel group. The terminal acquires the first level being 5 corresponding to the second channel group, the first level being 5 corresponding to the third channel group, and the first level being 5 corresponding to the fourth channel group from the table of the mapping relationship between the numerical value ranges and the levels as shown in Table 5, according to the numerical value range being 90 to 93 bytes corresponding to the second channel group, the numerical value range being 94 to 97 bytes corresponding to the third channel group, and the numerical value range being 94 to 97 bytes corresponding to the fourth channel group.

Step 405: The terminal respectively fills the reserved field of the BSR sub-header and the buffer size field of the BSR control element with the second level and the first level of the selected channel group, and fills the buffer size field of the BSR control element with the first level corresponding to each other unselected channel group.

In this embodiment, the channel groups respectively corresponding to the first buffer size field, the second buffer size field, the third buffer size field, and the fourth buffer size field in the BSR control element are agreed in advance.

For example, it is agreed in advance that the first buffer size field, the second buffer size field, the third buffer size field, and the fourth buffer size field in the BSR control element respectively correspond to the first channel group, the second channel group, the third channel group, and the fourth channel group.

Then, the reserved field of the BSR sub-header is filled with the binary 10 of the second level 2 of the selected first channel group, and the acquired BSR sub-header is as shown in Table 8.

TABLE 8

| R R | | E | LC ID | | | | |
|---|---|---|---|---|---|---|---|
| 1 | 0 | 0 | 1 | 1 | 1 | 0 | 1 |

The first buffer size field of the BSR control element is filled with the first level 5 corresponding to the first channel, the second buffer size field of the BSR control element is filled with the first level 5 corresponding to the second channel, the third buffer size field of the BSR control element is filled with the first level 5 corresponding to the third channel, and the fourth buffer size field of the BSR control element is filled with the first level 5 corresponding to the fourth channel; where binary of 5 is 000101, and the acquired BSR control element is as shown in Table 9.

TABLE 9

| | | | | | | | |
|---|---|---|---|---|---|---|---|
| 0 | 0 | 0 | 1 | 0 | 1 | 0 | 0 |
| 0 | 1 | 0 | 1 | 0 | 0 | 0 | 1 |
| 0 | 1 | 0 | 0 | 0 | 1 | 0 | 1 |

The BSR message is formed by the BSR sub-header as shown in Table 8 and the BSR control element as shown in Table 9, and then the terminal sends the BSR message with the formation as shown in Table 8 and Table 9 to the base station.

Step 406: The base station receives the BSR message, determines a channel group according to the preset rule, and extracts the first level and the second level that are corresponding to the channel group from the BSR message, and the first level corresponding to each other undetermined channel group.

Specifically, the base station receives the BSR message, determines a channel group according to the preset rule, extracts the first levels corresponding to the determined channel group and each other undetermined channel group from the BSR control element of the BSR message, and extracts the second level corresponding to the determined channel group from the reserved field of the BSR sub-header of the BSR message.

For example, the preset rule is that the channel group with the maximum priority is selected, the base station determines the first channel group with the maximum priority according to the preset rule, and other undetermined channel groups are respectively the second channel group, the third channel group, and the fourth channel group, the base station respectively extracts the first level 5 corresponding to the first channel group, the second channel group, the third channel group, and the fourth channel group from the BSR control element of the BSR message, and extracts the second level 2 corresponding to the first channel group from the reserved field of the BSR sub-header of the BSR message.

Step 407: The base station acquires the corresponding numerical value range according to the first level and the second level that are corresponding to the determined channel group, and determines a maximum of the acquired numerical value range as the size of the air interface resource allocated to the determined channel group.

Specifically, the base station acquires the corresponding numerical value range from the stored table of the mapping relationship between the numerical value ranges and the levels according to the first level and the second level corresponding to the determined channel group, and determines the maximum of the acquired numerical value range as the size of the air interface resource allocated to the determined channel group.

For example, the base station acquires the corresponding numerical value range being 98 to 101 bytes from the table of the mapping relationship between the numerical value ranges and the levels as shown in Table 5 according to the first level 5 and the second level 2 corresponding to the first channel group, and determines the maximum being 101 bytes of the numerical value range as the size of the air interface resource allocated to the first channel group.

Step 408: The base station acquires the numerical value range corresponding to each other undetermined channel group according to the extracted first level corresponding to each other undetermined channel group, and determines the maximum of the numerical value range corresponding to each other undetermined channel group as the size of the air interface resource allocated to each other undetermined channel group.

Specifically, the base station acquires the numerical value range corresponding to each other undetermined channel group from a stored table of the mapping relationship between the numerical value ranges and the first levels according to the extracted first level of each other undetermined channel group, and determines the maximum of the numerical value range corresponding to each other undetermined channel group as the size of the air interface resource allocated to each other undetermined channel group.

In this embodiment, the table of the mapping relationship between the numerical value ranges and the first levels as shown in Table 10 is stored in the base station in advance.

TABLE 10

| Numerical Value | |
|---|---|
| Range | First level |
| . . . | . . . |
| 90 to 105 bytes | 5 |
| . . . | . . . |

For example, according to the first level 5 of the second channel group, the first level 5 of the third channel group, and the first level 5 of the fourth channel group, the numerical value range being 90 to 105 bytes corresponding to the second channel group, the numerical value range being 90 to 105 bytes corresponding to the third channel group, and the numerical value range being 90 to 105 bytes corresponding to the fourth channel group are respectively acquired from the table of the mapping relationship between the numerical value ranges and the first levels as shown in Table 10, and 105 bytes are determined as the size of the air interface resources allocated to each of the second channel group, the third channel group, the fourth channel group.

Step 409: The base station allocates the air interface resource to the determined channel group according to the size of the air interface resource allocated to the determined channel group, and allocates the air interface resource to each other undetermined channel group according to the size of the air interface resource allocated to each other undetermined channel.

For example, according to a size being 101 bytes of the air interface resource allocated to the first channel group, the air interface resource being 101 bytes is allocated to the first channel group; according to a size being 105 bytes of the air interface resource allocated to the second channel group, the air interface resource being 105 bytes is allocated to the second channel group; according to a size being 105 bytes of the air interface resource allocated to the third channel group, the air interface resource being 105 bytes is allocated to the third channel group; and according to a size being 105 bytes of the air interface resource allocated to the fourth channel group, the air interface resource being 105 bytes is allocated to the fourth channel group.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of the data buffered in a terminal, and thereby a utilization ratio of the air interface resource is improved, and the air interface resource is saved.

### Embodiment 5

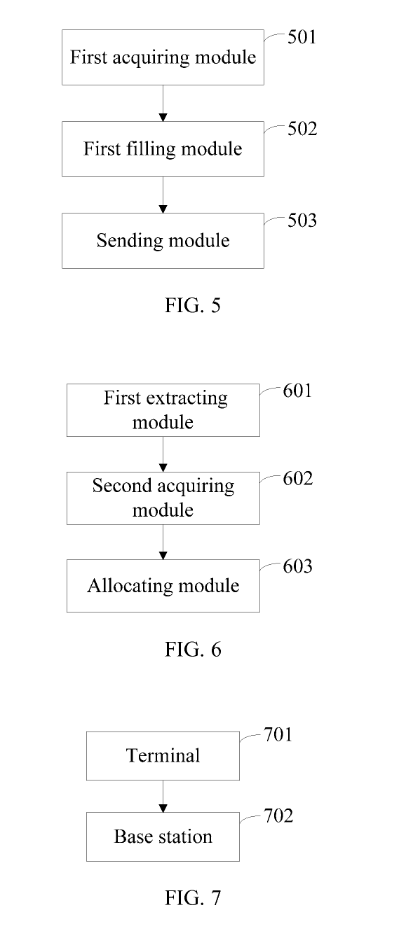

As shown in FIG. 5, an embodiment of the present invention provides a terminal, which includes:

a first acquiring module 501, configured to acquire, according to the amount of data buffered in a buffer corresponding to the channel group, a first level and a second level that are corresponding to a channel group, where the first level is used to indicate a numerical value range, and the second level is used to further indicate, in the numerical value range indicated by the first level, a numerical value range of the amount of the data buffered in the buffer;

a first filling module 502, configured to fill a BSR control element of a BSR message with the first level, and fill a BSR sub-header of the BSR message with the second level; and

a sending module 503, configured to send the BSR message to a base station, and request the base station to allocate the air interface resource.

The first acquiring module 504 is specifically configured to acquire, according to the amount of the data buffered in the buffer, the first level and the second level that are corresponding to the channel group by querying a table of the mapping relationship between the numerical value ranges and the levels.

The first filling module 502 includes:

a first filling unit, configured to fill a buffer size field of the BSR control element of the BSR message with the first level; and

a second filling unit, configured to fill a reserved field of the BSR sub-header of the BSR message with the second level.

Further, the terminal further includes:

a selecting module, configured to select a channel group from multiple channel groups according to a preset rule, if the BSR message is a long BSR message.

The terminal further includes:

a second filling module, configured to acquire another first level corresponding to another unselected channel group according to another amount of the data buffered in a buffer corresponding to the another unselected channel group in the multiple channel groups, where the another first level is used to indicate a numerical value range of the another amount of the data, and fill the BSR control element of the BSR message with the another first level.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of the data buffered in a terminal, and thereby a utilization ratio of the air interface resource is improved, and the air interface resource is saved.

### Embodiment 6

As shown in FIG. 6, an embodiment of the present invention provides a base station, which includes:

a first extracting module 601, configured to receive a BSR message, and respectively extract a first level and a second level that are corresponding to a channel group from a BSR control element and a BSR sub-header of the BSR message, where the first level is used to indicate a numerical value range, and the second level is used to further indicate, in the numerical value range indicated by the first level, a more specific numerical value range;

a second acquiring module 602, configured to acquire, according to the first level and the second level, a size of the air interface resource allocated to the channel group; and

an allocating module 603, configured to allocate the air interface resource of the acquired size to the channel group.

The first extracting module 601 includes:

a receiving unit, configured to receive the BSR message;

a first extracting unit, configured to extract the first level corresponding to the channel group from a buffer size field of the BSR control element of the BSR message; and

a second extracting unit, configured to extract the second level corresponding to the channel group from a reserved field of the BSR sub-header of the BSR message.

The second acquiring module 602 includes:

a second acquiring unit, configured to acquire, according to the first level and the second level, a more specific numerical value range by querying a table of the mapping relationship between the numerical value ranges and the levels, and use the more specific numerical value range as a numerical value range of the amount of the data corresponding to the channel group; and

a second determining unit, configured to determine the size of the air interface resource allocated to the channel group according to a maximum of the numerical value range of the amount of the data.

Further, the BSR message is a long BSR message.

The base station further includes:

a determining module, configured to determine, according to a preset rule, a channel group that has the first level and the second level, if the control element of the BSR message is filled with first levels of multiple channel groups.

Correspondingly, the base station further includes:

a second extracting module, configured to extract another first level corresponding to another undetermined channel group from the control element of the BSR message, where the another first level is used to indicate a numerical value range of the another amount of the data, and allocate the air interface resource to the another undetermined channel group according to the another first level.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and that amount of the data buffered in a terminal, and thereby a utilization ratio of the air interface resource is improved, and the air interface resource is saved.

### Embodiment 7

As shown in FIG. 7, an embodiment of the present invention provides a system for allocating an air interface resource, which includes a terminal 701 and a base station 702.

The terminal 701 is configured to acquire, according to the amount of the data buffered in a buffer corresponding to the channel group, a first level and a second level that are corresponding to a channel group; fill a BSR control element of a BSR message with the first level, and fill a BSR sub-header of the BSR message with the second level; and send the BSR message to a base station, where the second level is a sub-level of the first level, the first level is used to indicate a numerical value range, and the second level is used to further indicate, in the numerical value range indicated by the first level, a numerical value range of the amount of the data buffered in the buffer.

The base station 702 is configured to receive the BSR message, and respectively extract the first level and the second level that are corresponding to the channel group from the BSR control element and the BSR sub-header of the BSR message; acquire, according to the first level and the second level, a size of the air interface resource allocated to the channel group; and allocate the air interface resource of the size to the channel group.

In the embodiment of the present invention, a BSR control element of a BSR message is filled with a first level, and a reserved field of a BSR sub-header of the BSR message is filled with a second level, a combination of the first level and the second level corresponds to a numerical value range, so that division of the numerical value range is more refined, thereby reducing a difference value between a size of an air interface resource determined by a base station and the amount of the data buffered in a terminal, and thereby a utilization ratio of the air interface resource is improved, and the air interface resource is saved.

All or a part of the content of the technical solutions according to the embodiments may be implemented by software programming. A software program may be stored in a readable storage medium, which may be a hard disk, an optical disk, or a floppy disk in the computer.

It should be understood that the above descriptions are merely specific embodiments of the present invention, but not intended to limit the present invention. Any modification, equivalent replacement, or improvement made without departing from the spirit and principle of the present invention should fall within the protection scope of the present invention.

1. A method for allocating an air interface resource, comprising:
acquiring, according to an amount of data buffered in a buffer corresponding to a channel group, a first level and a second level that are corresponding to the channel group, wherein the first level is used to indicate a numerical value range, and the second level is used to further indicate, in the numerical value range, a numerical value range of the amount of the data;
filling a Buffer Status Report (BSR) control element of a BSR message with the first level, and filling a BSR sub-header of the BSR message with the second level; and
sending the BSR message to a base station, and requesting the base station to allocate the air interface resource.

2. The method according to claim 1, wherein the acquiring, according to the amount of the data buffered in the buffer, the first level and the second level that are corresponding to the channel group comprises:
acquiring, according to the amount of the data buffered in the buffer, the first level and the second level that are corresponding to the channel group by querying a table of a mapping relationship between numerical value ranges and levels.

3. The method according to claim 1, wherein the filling the BSR control element of the BSR message with the first level, and filling the BSR sub-header of the BSR message with the second level comprises:
filling a buffer size field of the BSR control element of the BSR message with the first level, and filling a reserved field of the BSR sub-header of the BSR message with the second level.

4. The method according to claim 1, wherein the BSR message is a long BSR message;
before the acquiring, according to the amount of the data buffered in the buffer corresponding to the channel group, the first level and the second level that are corresponding to the channel group, the method further comprises:
selecting the channel group from multiple channel groups according to a preset rule;
before sending the BSR message to the base station, and requesting the base station to allocate the air interface resource, the method further comprises:
acquiring, according to another amount of data buffered in a buffer corresponding to another unselected channel group in the multiple channel groups, another first level corresponding to the another unselected channel group, wherein the another first level is used to indicate a numerical value range of the another amount of the data, and filling the BSR control element of the BSR message with the another first level.

5. A method for allocating an air interface resource, comprising:
receiving a Buffer Status Report (BSR) message, and respectively extracting a first level and a second level that are corresponding to a channel group from a BSR control element and a BSR sub-header of the BSR message, wherein the first level is used to indicate a numerical value range, and the second level is used to further indicate a specific numerical value range within the numerical value range;
acquiring, according to the first level and the second level, a size of the air interface resource allocated to the channel group; and
allocating the air interface resource of the size to the channel group.

6. The method according to claim 5, wherein the respectively extracting the first level and the second level that are corresponding to the channel group from the BSR control element and the BSR sub-header of the BSR message comprises:
extracting the first level corresponding to the channel group from a buffer size field of the BSR control element of the BSR message; and
extracting the second level corresponding to the channel group from a reserved field of the BSR sub-header of the BSR message.

7. The method according to claim 5, wherein the acquiring, according to the first level and the second level, the size of the air interface resource allocated to the channel group, comprises:
acquiring, according to the first level and the second level, the specific numerical value range by querying a table of a mapping relationship between numerical values range and levels;
using the specific numerical value range as a numerical value range of the amount of data corresponding to the channel group; and
determining, according to a maximum of the numerical value range of the amount of the data, the size of the air interface resource allocated to the channel group.

8. The method according to claim 5, wherein the BSR message is a long BSR message;
before the respectively extracting the first level and the second level that are corresponding to the channel group from the BSR control element and the BSR sub-header of the BSR message, the method further comprises:
if the control element of the BSR message is filled with first levels of multiple channel groups, determining the channel group from the multiple channel groups according to a preset rule;
the method further comprises:
extracting another first level corresponding to another undetermined channel group from the control element of the BSR message, wherein the another first level is used to indicate a numerical value range of another amount of data, and allocating the air interface resource to the another undetermined channel group according to the another first level.

9. A terminal, comprising:
a first acquiring module, configured to acquire, according to an amount of data buffered in a buffer corresponding to a channel group, a first level and a second level that are corresponding to the channel group, wherein the first level is used to indicate a numerical value range, and the second level is used to further indicate, in the numerical value range, a numerical value range of the amount of the data;
a first filling module, configured to fill a Buffer Status Report (BSR) control element of a BSR message with the first level, and fill a BSR sub-header of the BSR message with the second level; and
a sending module, configured to send the BSR message to a base station, and request the base station to allocate an air interface resource.

10. The terminal according to claim 9, wherein
the first acquiring module is specifically configured to acquire, according to the amount of the data buffered in the buffer, the first level and the second level that are corresponding to the channel group by querying a table of a mapping relationship between numerical values range and levels.

11. The terminal according to claim 9, wherein the first filling module comprises:
a first filling unit, configured to fill a buffer size field of the BSR control element of the BSR message with the first level; and
a second filling unit, configured to fill a reserved field of the BSR sub-header of the BSR message with the second level.

12. The terminal according to claim 9, further comprising:
a selecting module, configured to select the channel group from multiple channel groups according to a preset rule, if the BSR message is a long BSR message;
the terminal further comprising:
a second filling module, configured to acquire, according to another amount of data buffered in a buffer corresponding to another unselected channel group in the multiple channel groups, another first level corresponding to the another unselected channel group, wherein the another first level is used to indicate a numerical value range of the another amount of the data, and fill the BSR control element of the BSR message with the another first level.

13. A base station, comprising:
a first extracting module, configured to receive a Buffer Status Report (BSR) message, and respectively extract a first level and a second level that are corresponding to a channel group from a BSR control element and a BSR sub-header of the BSR message, wherein the first level is used to indicate a numerical value range, and the second level is used to further indicate a specific numerical value range within the numerical value range;
a second acquiring module, configured to acquire, according to the first level and the second level, a size of an air interface resource allocated to the channel group; and
an allocating module, configured to allocate the air interface resource of the size to the channel group.

14. The base station according to claim 13, wherein the first extracting module comprises:
a receiving unit, configured to receive the BSR message;
a first extracting unit, configured to extract the first level corresponding to the channel group from a buffer size field of the BSR control element of the BSR message; and
a second extracting unit, configured to extract the second level corresponding to the channel group from a reserved field of the BSR sub-header of the BSR message.

15. The base station according to claim 13, wherein the second acquiring module comprises:
a second acquiring unit, configured to acquire, according to the first level and the second level, the specific numerical value range by querying a table of a mapping relationship between numerical value ranges and levels, and use the specific numerical value range as a numerical value range of the amount of data corresponding to the channel group; and
a second determining unit, configured to determine, according to a maximum of the numerical value range of the amount of the data, the size of the air interface resource allocated to the channel group.

16. The base station according to claim 15, wherein the BSR message is a long BSR message;
the base station further comprising:
a determining module, configured to determine, according to a preset rule, the channel group that has the first level and the second level, if the control element of the BSR message is filled with first levels of multiple channel groups;
the base station further comprising:
a second extracting module, configured to extract another first level corresponding to another undetermined channel group from the control element of the BSR message, wherein the another first level is used to indicate a numerical value range of another amount of data, and allocate, according to the first level corresponding to the another undetermined channel group, the air interface resource to the another undetermined channel group.
